(19) United States
(12) Patent Application Publication
(10) Pub. No.: US 2010/0114903 A1
(43) Pub. Date: May 6, 2010

(54) Internet-based targeted information retrieval system

(76) Inventors: Craig Harris, Santa Barbara, CA (US); Daniel Cudahy, Santa Barbara, CA (US); David Ruehlman, Lompoc, CA (US)

Correspondence Address: MARK RODGERS, 1590 SAN ROQUE ROAD, SANTA BARBARA, CA, 93105, US

(21) Appl. No.: 12/655,409

(22) Filed: Dec. 30, 2009

Related U.S. Application Data
(63) Continuation of application No. 11/827,787, filed on Jul. 13, 2007.

(51) Int. Cl. G06F 17/30

(52) U.S. Cl. 707/741; 707/803; 707/E17.002; 707/E17.044

(57) ABSTRACT

The invention is a system and process, whereby using source data, facts related to the source data are found primarily on the open internet. These related facts may be found on totally unrelated websites. The facts are indexed to create a high value database of profiles of individuals or organizations. In a specific disclosed embodiment, the facts relate to donations made to non-profit organizations, creating a database highly valuable to those soliciting donations.

### RELATED APPLICATIONS

This application is a continuation of application Ser. No. 11/827,787 filed Jul. 13, 2007

### FEDERALLY SPONSORED RESEARCH

Not Applicable

### SEQUENCE LISTING

Not Applicable

### BACKGROUND OF THE INVENTION

This invention relates to acquiring unstructured facts related to a particular subject from the open internet and creating a high value database from these facts, by structuring and relating these facts to other data in a searchable format. In a particular disclosed embodiment, the subject is donors and donations made to non-profit organizations, and the value is for those who want to target donation solicitations to likely donors.

The internet by its nature contains a tremendous amount of information. In many cases, information that is inherently related exists piecemeal on websites that may have no obvious relation to each other. Much of this information, if collected and properly correlated, could be of high value. For instance, an annual report from a non-profit organization, published on the web, may contain a list of donors and the amounts donated. From this list, it would be possible to search the web for further information about the specific donors and the related organization. This research may indicate not only the donor's capacity to give but their affinity or area of philanthropic interest. This information may be found on websites that have nothing to do with the annual report.

For example, searching for the donor may uncover information such as sports teams the donor is involved in, civic groups he joins, or even information about his occupation, if he is involved in work that publishes or otherwise makes public announcements. From this information a profile of the donor's interests, activities, geographical location and income level may be derived. One may infer from related information from the internet that said data is about a person with the same name; however, the effectiveness of using such information has been limited to date. The key elements of effectively qualifying and relating information from seemingly unrelated web-pages are not effective in the current art. Similarly, searching the web for information about a non-profit organization may uncover more information such as testimonials from those who received aid or other published news about the organization, thereby providing a more complete picture about the work the organization does, and where it does its work. Such profile information about donors and the organizations a specific donor made donations to, clearly could be of very high value to anyone trying to actively target donation solicitations.

So starting with information from a source, such as an annual report, one can go to the web and find a wealth of information pertinent to a particular subject on totally unrelated web sites. The example of donations to non-profits is used throughout this application, but many variations related to marketing, security, social networking and others share common attributes, namely that starting with source data, other data pertinent to the source data can be found. Rudimentary versions of this concept are found in internet advertising, where when a user clicks on a webpage, data in the user's cookie may be used to specifically target what ads are placed in pop-up windows based on geographical and other demographic information in the cookie. However it is desirable to obtain richer profiles of a donor's donation capacity as well as affinity, based on information freely available on the open web, without the use of cookies.

Therefore it is the object of this invention to create a system and process whereby high value profile information may be created by accessing information primarily from the internet and, most importantly, qualifying and relating the information to form a useful database. It is a specific object of this invention to apply the teachings of the invention to the case of donations made to non-profit organizations.

### BRIEF SUMMARY OF THE INVENTION

The invention is a process for creating a searchable database, and includes the steps of indexing individual facts which exist within a web page, appending additional facts from other sources, relating the indexed/appended facts to facts already indexed, thereby creating the database and providing a searchable format for the database.

In particular embodiments, the process further includes analyzing a webpage related to an indexed fact to derive additional facts, and the searchable format is a data file.

In various embodiments, the process includes one or more of the following: allowing a user to search the data file for a fee, allowing a user to screen a list of facts against the data file for a fee, or licensing the data file to a user for a fee.

In preferred embodiments, the database contains facts about donations to non-profit organizations, and the facts may be related to categories including organizations the donations are made to, donors making the donations, geographical information about donors and organizations, and size and category of the donations.

### BRIEF DESCRIPTION OF THE DRAWINGS

The invention will be better understood by referring to the following figures.

FIG. 1 schematically shows the top-level operation of the invention.

FIG. 2 shows the types of information and where the information originates for the case of donations made to non-profits.

FIG. 3 illustrates the relating of information from seemingly unrelated sources.

### DETAILED DESCRIPTION OF THE INVENTION

The invention will be described using the version implemented by the inventors, which creates a high value database aimed at anyone interested in soliciting donations and donor prospect research. However, those skilled in these arts will readily appreciate that the teachings disclosed may be applied to other subjects with beneficial results. Thus, the specific example disclosed should not be assumed as limiting the scope of the invention and appended claims.

An actual implemented embodiment of the invention is utilized to produce a database containing facts about donations to non-profit organizations. Unstructured source data is acquired from open Internet sources, qualified, standardized, structured, and indexed into a relational database file. The information contained includes but is not limited to: facts related to the type of organization the donations are made to, facts about the type of donation being made, facts about the type of donor making the donation, geographical information about donors and organizations, and the link to the internet web page where the data elements were obtained. Various indexed facts can be related to one another given the donor and the organization to which they gave a donation, utilizing inductive reasoning. Using these inductive methods, relationships can be established between data sets by detailed consideration of indexed facts (data elements) within controlled data groups. Upon inducing relationships, additional valuable information from other websites (or data already included within the index) can be appended and indexed within the data base. Examples of using inductive reasoning to relate data elements will be shown below.

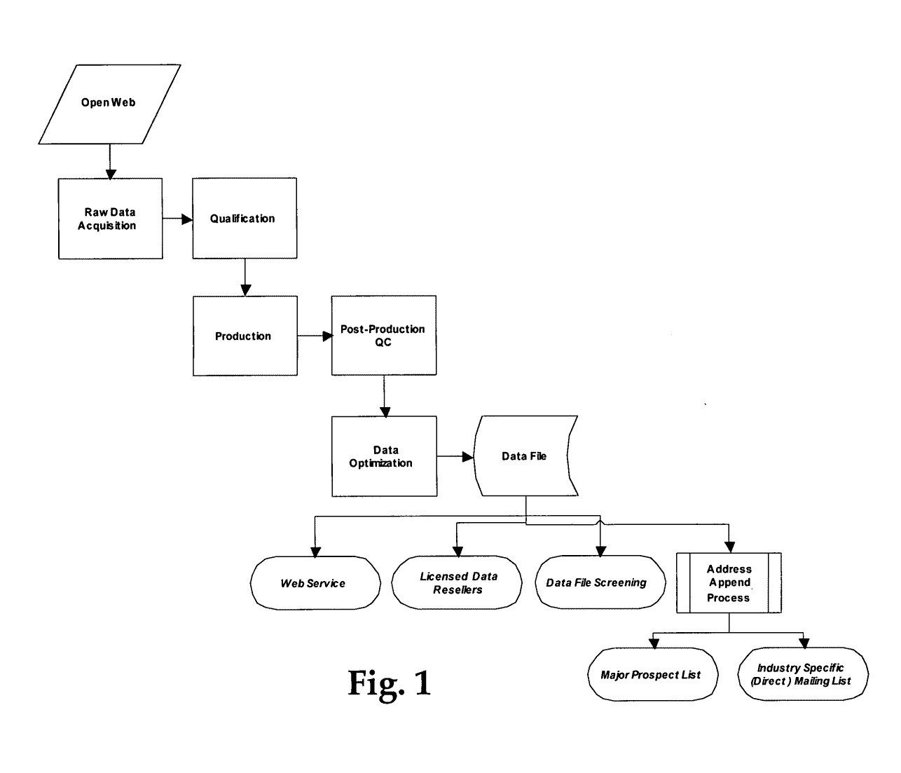

Referring to FIG. 1, the invention at its top level will be described. Raw, unstructured source data is initially acquired from the open internet, based on a wide variety of specific target criteria. In the donation example for instance, the source data may be a list of donors published within an annual report by a non-profit organization. The entire internet or some significant portion may be searched for any web page that references non-profit organizations and/or donor names. In theory, this acquisition process could be done entirely manually, using an individual or team of individuals to manually use search engines and look for any web pages containing appropriate keywords, such as donor names, derived from previous source data. However, in practice, the acquisition process is preferably at least semi-automated, utilizing optimized spiders searching the Open Web to acquire its source material (documents). Such optimized spiders are known in the art. From the results, it would be possible to manually search the web for further information about the specific donors and related organizations.

Some of these websites will certainly have useful demographic information about the donors, including geographical location, possible interests, and others. Again, inductive reasoning methods provide the ability to analyze the indexed facts [data sets] and establish relationships which provide additional valuable information to both internal and external end users. Moreover, some data can be analyzed, such as the organization's mission statement and press releases or news appearances, to develop an indication of the type of donor that is attracted to a certain type of charitable activity. Thus relating a list of donors coupled with donation timing, donation amount and the organization's mission (a keyword such as “Homeless”) results in a wealth of information for the data file.

Upon acquisition, a quality analysis is performed to assess the source data's attributes and related website pages. Source information is scrutinized for relevancy and value, meaning the source actually contains information about specific donors and donations. Further, this quality analysis ensures that the donations listed in one source do not overlap or become duplicated by a donation noted in another source document, from the same organization. This process makes certain that the data (facts) produced by the invention are accurate. Thus using the donor example, the source data donor list, its specific organization, as well as its related web pages may be used and efficiently integrated as part of the data acquisition and production process.

Facts are harvested from the source data with a process known in the art as web-scraping, however the teachings of this application may be practiced without resorting to the inventor's particular web-scraping technique. A critical component of the inventor's data processing is the function of standardizing the data. Standardizing the source data serves as a method to organize unstructured or semi-structured data elements into an optimized, structured format ensuring more effective and efficient search results for the end users. Furthermore, the structured data formatting provides a robust ability to integrate specific portions of the data sets with other internal and external applications. The teachings of this application may be practiced without resorting to the inventor's particular application details. Standardization consists of a series of automated and semi-automated process applications utilizing Natural Language Recognition-based semantic and syntax modeling along with a binary decision tree, to critically analyze and manipulate textual data formats. This processing application has features which analyze and process data in methods which may include: reformatting text, combining or separating multiple portions of text, sorting, etc. An example of donor data found within a university's annual report which was noted as “John Smith (BA′56)” can be standardized to “John Smith, BA, Class of 1956”. An additional example is the ability to automatically parse a list of names printed as a single symbol separated text string (“David Brown*Shawn Briley*Alfred and Sara Cross*etc . . . ” reformatted to a standardized list format, capable of further editing.

By appending information it becomes apparent that harvested facts are often related to additional facts within the source information. An example of this is the case of appending or relating a series of donor names making a donation in memory of a single [named] deceased individual (example: Sara Kline, in memory of John Smith; Robert Krause, in memory of John Smith, and so on). This type of information can be valuable when researching the philanthropic giving habits of a prospective donor.

Again referring to FIG. 1, after processing and standardizing the data, data is further optimized, such as typing the donors into categories (individual, foundation, corporate, etc.). Data optimization can serve to add value to the source data by further appending additional industry-specific searchable information to previously indexed data within the data base. How this additional industry-specific information is derived is an example of inductive reasoning. Using the donor example, the inventors can specify the type of donor (individual, corporate or foundation) using applications which mirror the method by which a human, as part of a specific reasoning process, would associate a type with an entity. The application would automatically ‘type’ following list of donor names: Dr. Harry Schmidt Virology, David & Rena Flowers Family Trust, Mr. and Mrs. J. Stephen Powell, Brasfield & Frazer LLC; accordingly Dr. Harry Schmidt Virology (corporate), David & Rena Flowers Family Trust (foundation), Mr. and Mrs. J. Stephen Powell (individual), and Brasfield & Frazer LLC (corporate). The generation of controls that accurately assign donor types to donor can be seeded through a keyword index, feedback loop applications, and analysis of specific textual token patterns to thus determine entity [donor] types.

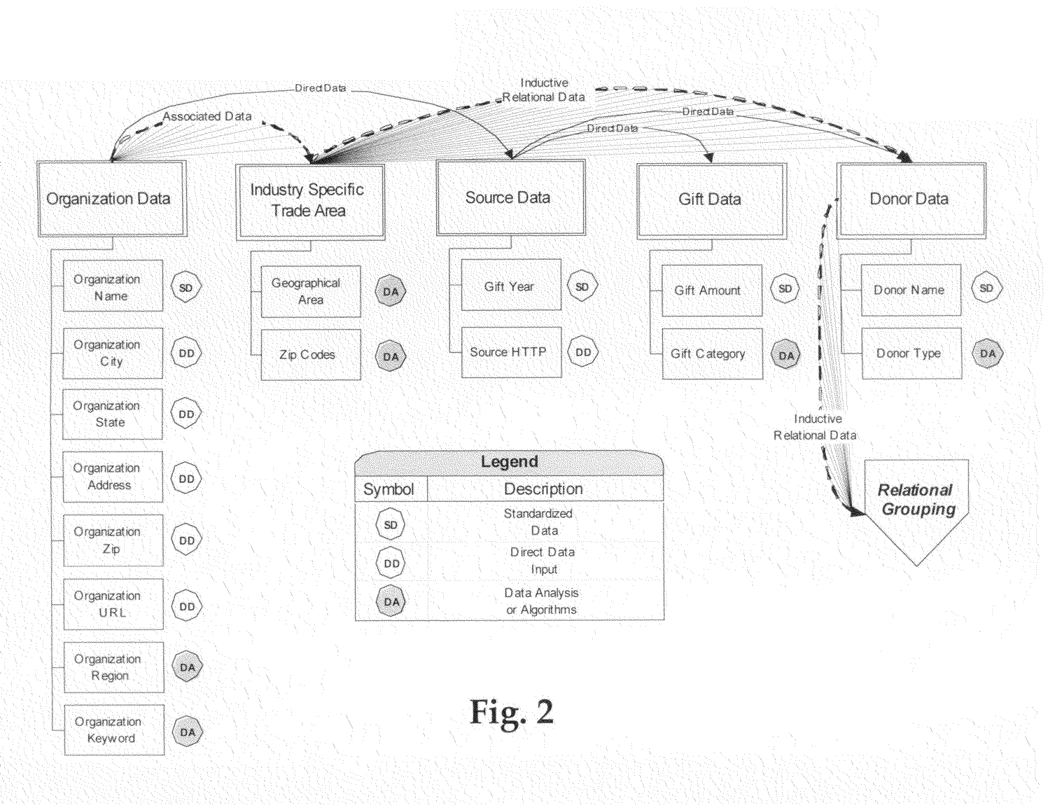

Turning to FIG. 2, a detailed picture of the inputs to the donor data file are shown. Each input is marked by a code: SD, DD, or DA. Some data, coded as SD, is standardized prior to integration with the inventor's data files; this turns out to be the bulk of the actual data in terms of actual data amounts. A good example of SD is a donor list from a web published annual report which provides the starting point for web-scraping. Second is direct data, coded DD, which is assimilated into the inventor's data files without any manipulation. Direct data is taken without alteration from source documents, an example being the non-profit organization's address. A third type of data, coded DA, which is data that is developed by analysis of DD and SD data. Examples of data which has been produced through analysis are donor [entity] type (noted prior), or organizational keywords derived from review and assessment of the organization's mission statement and the type of work the organization does, for example “homeless”, “cancer research” or “ocean water quality”. Such information derived from analysis can be used to find potential donors through their past giving history, interests or family information.

Further data file optimization can occur through a series of processes which quantify relationships between specific data entities by analyzing textual data and assessing relationships within controlled groups. Relational Grouping is a critical step in the Natural Language Recognition of proper names as compared to other like proper names. The use of such logic to eliminate like names that are not the donors of interest has been described above, but the same logic can be used to group names into useful categories. For example, Through the use of fuzzy logic, a determination can be made as to whether several pieces of data (names) actually relate to other data (names) and therefore should be combined. The inventors use several variables to calculate which (if any) of the records are actually the “same person” or even the “same household” within a controlled group. Each Entity is objectively compared mathematically to each subsequent Entity, assessing the match probability. If the probability exceeds match criteria, these two entities are considered the same. Additionally, these groups are then compared to other groups to allow further relationships. For example, if our first group included “Bill Clinton”, “William Clinton”, and “Pres. Bill Clinton”; and our second group included “Hillary Clinton” and “President and Hillary Clinton”, the inventors can combine these into a known single household, based on looking at other information related to the various names, such as zip codes of the organizations to which they gave. Clearly a variety of related information to a particular name could be used to group seemingly disparate entities or eliminate entities with similar names, and such qualifying and grouping criteria will be apparent to those skilled in the art. Given that donor names are standardized, entity typed for consistency, and matched against other information previously attained, grouping new donors utilizing relationship criteria provides a greater understanding about a given donor.

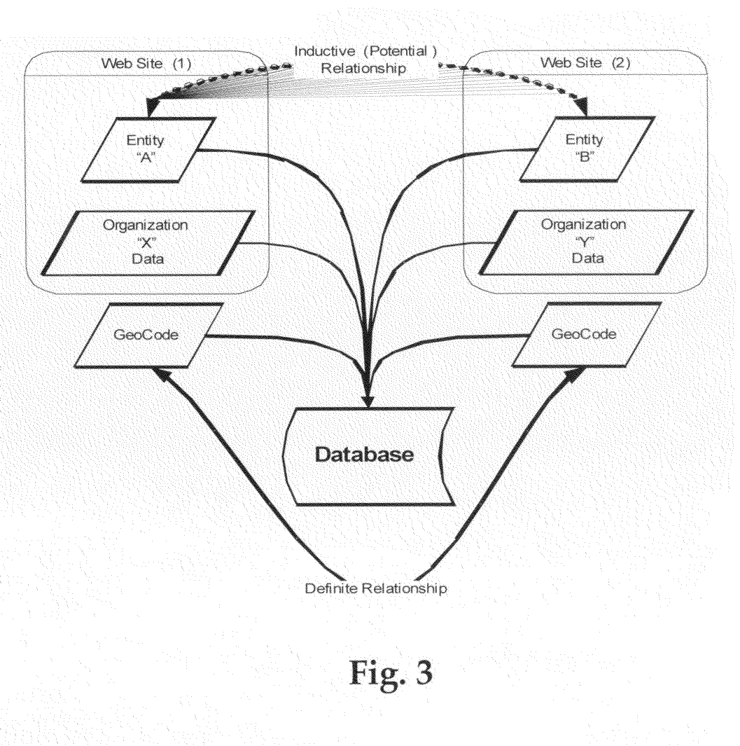

The net result is shown in FIG. 3, achieving the objects of the invention, such that information on websites 1 and 2 may have a relationship that has nothing to do with the websites themselves. The invention, by starting with a reason to look at the websites, such as the source data from a non-profit, extracts the facts that are related and populates the database for a user to see the relationship. The net result is a powerful tool for the use of the freely available but largely uncorrelated data which can be accessed on the internet.

The inventors' data file produced from the described process has value from a business standpoint. For instance, the inventors have used the techniques described above to create a donor/non-profit organization data file, which will be made available to users in a variety of ways. Users may log-on to a fee based website and submit search queries to the data file, paying on a per search result or subscription basis. As an example, users may produce a prospective donor list by querying the data file, “who in the state of California gave more than $5000 to organizations helping the homeless?” Alternatively a user could query the data file with, “what donations were made by ‘Allison Jenkins’, to organizations in Kentucky, since 2003?”. The relational database's ability to be queried in such a manner is a very effective tool in the field of prospective donor research and soliciting practiced by non-profit organizations. Again, those skilled in these arts will readily appreciate that the teachings disclosed may be applied to other subjects with beneficial results. Accordingly, the specific examples disclosed should not be assumed as limiting the scope of the invention and appended claims.

The inventors may license all or portions of the data file to an organization for specific or unlimited use as another form of monetizing the data file. Licensing would specifically enable other ‘licensees’ the ability to integrate the data files (or subsets) with other technologies, such as other database files or graphic user interfaces. As an extension of licensing and integration, users/licensees can screen discrete data files against information contained within the inventor's database files. Within this process, either the inventor or licensees screens an external data source versus the inventor's relational data file, extracting specific relational data from the inventor's file. A specific example of a screening would be a University acquiring a license to screen the inventor's data file versus a select list of their alumni, to assess who among them donated more than $5000 to any organization in the last five years. The inventors' data file can be utilized, integrated, and screened internally as well as externally, in a multitude of methods which would provide ongoing revenue.

Upon quantifying relationships, data entities may have additional entity specific data appended to the data sets, such as addresses or donation data. Such a capability is described in another co-pending application by the inventors. The information specifically targeted by this process will utilize related donors within controlled groups. This process application cross references a regional (trade area) address registry against all potential related Entity [Donor] Names within control groups to assess potential matches. Thus, upon determining that certain records relate to the same person(s) or household, related data files can then be matched to specific address data files. Accordingly, all matched Entity [Donor] Names contained within the data file can be combined with appropriately matched addresses. Thus the foundation for direct marketing/fundraising mailing lists is made, creating a highly valuable tool in the non-profit fundraising industry. One particularly useful outcome of the address appending process applications is the production of Major Prospect Lists. Using the example of a non-profit homeless shelter initiating a fundraising mail campaign, the non-profit can utilize one of the inventor's direct mailing lists, and send ‘select’ campaign solicitation material to households with, “a known giving level of $5,000 or more to health and human services: homelessness organizations, within the last three years, in their particular geographic area”. Given that the data is consolidated within a relational database, the files produced can be distributed as a highly valuable industry-specific “market ready” Direct Mailings.

We claim:

1. A process for creating a searchable database, comprising;
indexing individual facts which exist within a web page,
appending additional facts from other sources,
relating the indexed/appended facts to facts already indexed,
thereby creating the database; and,
providing a searchable format for the database.

2. The process of claim 1 further comprising analyzing a webpage related to an indexed fact to derive additional facts.

3. The process of claim 1 wherein the searchable format is a data file.

4. The process of claim 3 further comprising allowing a user to search the data file for a fee.

5. The process of claim 3 further comprising allowing a user to screen a list of facts against the data file for a fee.

6. The process of claim 3 further comprising licensing the data file to a user for a fee.

7. The process of claim 1 wherein the database contains facts about donations to non-profit organizations.

8. The process of claim 1 wherein the facts are related to categories including:
organizations the donations are made to,
donors making the donations,
geographical information about donors and organizations; and,
size and category of the donations.
